(19) United States
(12) Patent Application Publication
(10) Pub. No.: US 2025/0014093 A1
(43) Pub. Date: Jan. 9, 2025

(54) INFORMATION PROCESSING APPARATUS

(71) Applicant: TOYOTA JIDOSHA KABUSHIKI KAISHA, Toyota-shi (JP)

(72) Inventors: Masaki MAKIHARA, Okazaki-shi (JP); Kazuyuki SAKUMA, Nagoya-shi (JP)

(73) Assignee: TOYOTA JIDOSHA KABUSHIKI KAISHA, Toyota-shi (JP)

(21) Appl. No.: 18/678,847

(22) Filed: May 30, 2024

(30) Foreign Application Priority Data
Jul. 5, 2023 (JP) 2023-110943

(51) Int. Cl. G06Q 30/0645; G06Q 50/18

(52) U.S. Cl. CPC G06Q 30/0645; G06Q 50/18

(57) ABSTRACT

An information processing apparatus comprises a controller comprising one processor configured to perform: receiving first information giving an instruction to output information on a payment amount in a case of re-signing up for a first plan involving an initial cost at the time of signing of a lease contract and not involving an early termination charge during a lease contract period or a second plan not involving the initial cost at the time of signing of the lease contract and involving the early termination charge during the lease contract period, setting the payment amount for each of the contractual plans during a recontract period such that a total of the payment amount during the recontract period is larger in a case where the contractual plan is the second plan than the first plan; and transmitting information on the payment amount during the recontract period to the user terminal.

### CROSS REFERENCE TO THE RELATED APPLICATION

This application claims the benefit of Japanese Patent Application No. 2023-110943, filed on Jul. 5, 2023, which is hereby incorporated by reference herein in its entirety.

### BACKGROUND

### Technical Field

The present disclosure relates to a technique for presenting a payment amount in a lease contract.

### Description of the Related Art

There are known many techniques for presenting a payment amount required to lease an article to a user.

In this relation, Japanese Patent Laid-Open No. 2003-067659 discloses a lease plan preparation method for regarding an amount obtained by subtracting a cost to be recovered over a shorter set period from a cost to be recovered over an entire lease period as a cost to be recovered from expiration of the set period to expiration of the entire lease period and calculating a lease fee, and the like.

### SUMMARY

The present disclosure has as its object to enhance satisfaction of a user which signs a lease contract.

One aspect of an embodiment of the present disclosure is an information processing apparatus comprising a controller comprising at least one processor configured to perform:
receiving, from a user terminal, first information giving an instruction to output information on a payment amount in a case of re-signing up for at least one of contractual plans for a lease contract for an object, which are a first plan involving an initial cost at the time of signing of the lease contract and not involving an early termination charge during a lease contract period and a second plan not involving the initial cost at the time of signing of the lease contract and involving the early termination charge during the lease contract period, after expiration of the lease contract period;
setting the payment amount for each of the contractual plans during a recontract period such that a total of the payment amount during the recontract period is larger in a case where the contractual plan is the second plan than in a case where the contractual plan is the first plan; and
transmitting information on the payment amount during the recontract period to the user terminal in response to the first information.

Other aspects include a method to execution of the process to be implemented by the above-described apparatus, a program for execution of the method, or a computer-readable storage medium non-transitorily storing the program.

According to the present disclosure, it is possible to enhance satisfaction of a user who signs a lease contract.

### BRIEF DESCRIPTION OF THE DRAWINGS

FIG. 1 is a conceptual diagram of a process to be implemented by a server apparatus according to an embodiment;

FIG. 2A is a chart illustrating a magnitude relationship among payment amounts for common contractual plans;

FIG. 2B is a chart illustrating a magnitude relationship of a payment amount for a post-change contractual plan;

FIG. 3 is a diagram for explaining constituent elements which a system including the server apparatus according to the embodiment has;

FIG. 4 is a flowchart of a process to be executed by a controller of the server apparatus according to the embodiment; and

FIG. 5 is a chart illustrating a magnitude relationship among payment amounts for contractual plans to be set by the server apparatus according to the embodiment.

### DESCRIPTION OF THE EMBODIMENTS

There is known a system which calculates and presents a monthly payment amount on the basis of a contractual plan selected by a user at the time of signing of a lease contract for a contract object (e.g., a vehicle).

For example, the idea of setting a first period shorter than the whole of a lease period (an entire lease period) and presenting a plan in which a payment amount during a period from expiration of the first period to expiration of the entire lease period is smaller than a payment amount during the first period is conceivable. As described above, the system can enhance satisfaction of a user who uses a single vehicle over a long period by lowering a payment amount halfway.

A user may desire to re-sign an identical lease contract after expiration of an entire lease period. The user may desire to re-sign the lease contract after expiration of the entire lease period, for example, for the reason that a period up to delivery of a vehicle which the user desires to switch to is long or for the reason that there is no vehicle that the user desires to switch to.

In this case, satisfaction of the user may decrease depending on the details of a signed-up-for plan.

An information processing apparatus according to the present disclosure sets a payment amount such that the total of a payment amount during a recontract period after expiration of an entire lease period is larger in a contractual plan which involves an initial cost and does not involve an early termination charge than in a contractual plan which does not involve an initial cost and involves an early termination charge.

The information processing apparatus transmits information on payment amounts for the above-described contractual plans to a user terminal in response to a request from the user terminal.

The information processing apparatus according to one aspect of the present disclosure is an information processing apparatus comprising a controller comprising at least one processor configured to perform: receiving, from a user terminal, first information giving an instruction to output information on a payment amount in a case of re-signing up for at least one of contractual plans for a lease contract for an object, which are a first plan involving an initial cost at the time of signing of the lease contract and not involving an early termination charge during a lease contract period and a second plan not involving the initial cost at the time of signing of the lease contract and involving the early termination charge during the lease contract period, after expiration of the lease contract period; setting the payment amount for each of the contractual plans during a recontract period such that a total of the payment amount during the recontract period is larger in a case where the contractual plan is the second plan than in a case where the contractual plan is the first plan; and transmitting information on the payment amount during the recontract period to the user terminal in response to the first information.

The first plan refers to a contractual plan for the lease contract for the lease object and a contractual plan which involves the initial cost at the time of signing of the lease contract and does not involve the early termination charge at the time of early termination during the lease contract period.

The second plan refers to a contractual plan for the lease contract for the lease object and a contractual plan which does not involve the initial cost at the time of signing of the lease contract and involves the early termination charge at the time of early termination during the lease contract period.

The user terminal is a terminal which accesses the information processing apparatus according to the one aspect of the present disclosure to obtain information on a payment amount for a contractual plan when a user signs the lease contract for the object. The user terminal is typically a smartphone, a tablet terminal, a wearable terminal, a personal computer, or the like.

The lease contract period refers to a contract period when the user signs the lease contract for the object. The lease contract expires in a predetermined period of, for example, three years or five years.

The recontract period refers to a new contract period when the user re-signs the lease contract for the identical object with a contractual plan identical to that for the expired lease contract at the time of expiration of the lease contract period for the object. The recontract period is started after expiration of the lease contract period.

The first information refers to information giving an instruction to output the information on the payment amount in re-signing after expiration of the lease contract period. The first information is transmitted from the user terminal to the information processing apparatus according to the one aspect of the present disclosure.

In a common vehicle lease contract, a plan (called the first plan) which allows extension of a contract period by re-signing but is larger in a monthly amount and the total of a payment amount than the second plan and a plan (called the second plan) which disallows extension of the contract period by re-signing but is smaller in a monthly amount and the total of a payment amount than the first plan may be available.

The first plan does not require an early termination charge but requires an initial cost instead, and is often larger in the total of a payment amount than the second plan that requires an early termination charge but does not require an initial cost (unless the lease contract is canceled during the lease contract period in the second plan).

Due to lengthening of periods up to delivery of vehicles, a situation may occur where a vehicle which a user is to use next cannot be prepared in a short period at a time when a lease contract ends. As a countermeasure against this, the idea of allowing extension of a contract period by re-signing in the second plan that originally disallows contract extension by re-signing such that an existing vehicle can be ongoingly used is conceivable.

However, if re-signing is allowed in the second plan, a user which re-signs up for the first plan larger both in a monthly amount and the total of a payment amount than the second plan is more disadvantageous in payment amount than a user who re-signs up for the second plan. With such payment amount setting, a user who has paid a larger monthly amount and the larger total of a payment amount in anticipation of re-signing may be dissatisfied.

For the above-described reason, an information processing apparatus according to the present disclosure sets a payment amount for each of contractual plans during a recontract period such that the total of a payment amount during the recontract period for the second plan is larger than the total of a payment amount during the recontract period for the first plan.

The controller transmits the information on the payment amount during the recontract period to the user terminal in response to the first information received from the user terminal. That is, the controller transmits information on a payment amount for the first plan or the second plan to the user terminal in response to the first information.

With the above-described configuration, the information processing apparatus according to the one aspect of the present disclosure can amend an inequality in financial burden in re-signing between a user which has paid a larger amount in anticipation of re-signing and other users. Thus, the information processing apparatus according to the one aspect of the present disclosure can enhance satisfaction of a user which signs a lease contract.

The object is an automobile, and the at least one processor is further configured to execute making a total of the payment amount during the recontract period in a case of signing the lease contract for a new car with the second plan and re-signing up for the second plan after expiration of the lease contract period larger than a total of the payment amount during the recontract period in a case of signing the lease contract for the new car with the first plan and re-signing up for the first plan after expiration of the lease contract period and smaller than a total of the payment amount during a first period which is a period identical to the recontract period in a case of signing a lease contract for a used car different from the new car for the first period with the first plan.

The above-described configuration allows avoidance of occurrence of a situation where a payment amount is smaller in a case of returning a vehicle and signing a lease contract for a used car than in a case of re-signing a lease contract for an identical vehicle.

A user can also sign the lease contract for a period identical to a combined period of the lease contract period and the recontract period with the second plan. In this case, the user signs with the cheaper second plan for the combined period with the intention to use a leased vehicle for a long period at the beginning. It is thus desirable to set a total payment amount in the case of signing with the second plan for the combined period smaller than a total payment amount for the first plan in the case of re-signing after expiration of the lease contract period.

For the above-described reason, the controller may be further configured to execute setting the payment amount for each of the contractual plans such that a total of the payment amount during a combined period of the lease contract period and the recontract period increases in the order of (1) a total of the payment amount for the second plan during a period identical to the combined period in a case of signing the lease contract for the period identical to the combined period at the time of first signing, (2) a total of the payment amount for the first plan during the combined period in a case of signing the lease contract for the lease contract period at the time of first signing and further signing the lease contract for a period identical to the recontract period after expiration of the lease contract period, and (3) a total of the payment amount for the second plan during the combined period in a case of signing the lease contract for the lease contract period at the time of first signing and further signing the lease contract for a period identical to the recontract period after expiration of the lease contract period.

With the above-described configuration, the information processing apparatus according to the one aspect of the present disclosure can make a payment amount in the case of signing the lease contract for a longest period at the time of first signing smallest. Thus, the information processing apparatus according to the one aspect of the present disclosure can enhance satisfaction of a user by making reasonable payment amount settings.

The controller may be further configured to execute setting, to identical amounts, a monthly amount of the payment amount for the second plan during a period identical to the recontract period in a case of signing the lease contract for a period identical to a combined period of the lease contract period and the recontract period at the time of first signing and the monthly amount of the payment amount for the second plan during the recontract period in a case of signing the lease contract for a period identical to the lease contract period at the time of first signing and further signing the lease contract for a period identical to the recontract period after expiration of the lease contract period.

With the above-described configuration, the information processing apparatus according to the one aspect of the present disclosure can make monthly payment amounts for the second plan in a case of signing the lease contract for the period identical to the combined period of the lease contract period and the recontract period at the time of first signing and in a case of signing the contract for the recontract period after expiration of the lease contract period identical. Thus, the information processing apparatus according to the one aspect of the present disclosure can enhance satisfaction of a user by setting a user-friendly contractual plan.

The information processing apparatus according to the one aspect of the present disclosure may further include a storage configured to store information on the payment amount during the lease contract period corresponding to each of the first plan and the second plan, wherein the at least one processor is configured to execute receiving, from the user terminal, second information giving an instruction to output information on a monthly amount of the payment amount during the recontract period for at least one of the first plan and the second plan as information on the payment amount in a case of re-signing up for the at least one of the first plan and the second plan, calculating the monthly amount of the payment amount for the first plan and the second plan during the recontract period on the basis of the information stored in the storage such that a total of the payment amount during the recontract period is larger for the second plan than for the first plan, and transmitting information on the monthly amount of the payment amount to the user terminal in response to the second information.

That is, the information processing apparatus may provide the information on the monthly amount of the payment amount during the recontract period on the basis of the stored information.

A specific embodiment of the present disclosure will be described below with reference to the drawings. A hardware configuration, a module configuration, a functional configuration, and the like described in each embodiment are not intended to limit a technical scope of the disclosure only thereto unless otherwise described.

### Embodiment

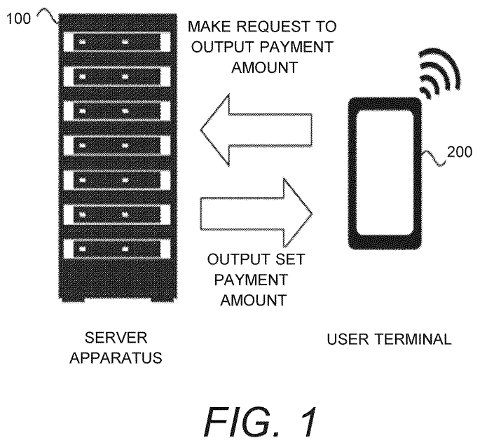

An outline of a process to be performed by a server apparatus according to an embodiment will be described with reference to FIG. 1. FIG. 1 is a conceptual diagram of a process to be implemented by a server apparatus 100 according to the embodiment. In the present embodiment, the server apparatus 100 communicates with a user terminal 200. The server apparatus 100 is a computer which provides information on a contract for a new car or used car leasing service online in response to a request from the user terminal 200. A user who is to use an online leasing service accesses a lease site (a website for signing a vehicle lease contract) through a web browser of the user terminal 200 and applies for a lease on a vehicle. The vehicle is a new car or a used car. The used car subsumes a previously leased vehicle and a rental car.

At the time of the provision, the server apparatus 100 provides information on an amount to be paid by the user as the information on the contract for the leasing service to the user terminal 200.

In the present embodiment, a first plan and a second plan are set as plans for a vehicle lease contract. The server apparatus 100 sets payment amounts for contractual plans including the first plan and the second plan.

The first plan here is a contractual plan which involves an initial cost at the time of signing of a vehicle lease contract and does not involve an early termination charge at the time of early termination during a lease contract period. The initial cost is a payment amount which needs to be paid first when a user signs the lease contract. The initial cost is a payment amount to be paid separately from a payment amount (e.g., a monthly lease amount) to be paid every predetermined period by the user. The user can sign up for the first plan provided that the user pays the initial cost. The early termination charge is a payment amount which needs to be paid when the user cancels the lease contract before expiration of a lease contract period. The user need not pay the early termination charge to terminate the first plan. In addition, for example, the user is required to pay a monthly amount corresponding to the first plan every month.

The second plan is a plan which does not involve an initial cost at the time of signing of a vehicle lease contract and involves an early termination charge at the time of early termination during a lease contract period. A user need not pay the initial cost at the time of signing up for the second plan. The user needs to pay the early termination charge to early terminate the second plan. In addition, for example, the user is required to pay a monthly amount corresponding to the second plan every month.

In the present embodiment, the server apparatus 100 sets a payment amount such that, at the time of re-signing up for the first plan or the second plan after expiration of a lease contract period, the total of a payment amount for the second plan during a recontract period is larger than the total of a payment amount for the first plan during the recontract period.

The setting will be specifically described.

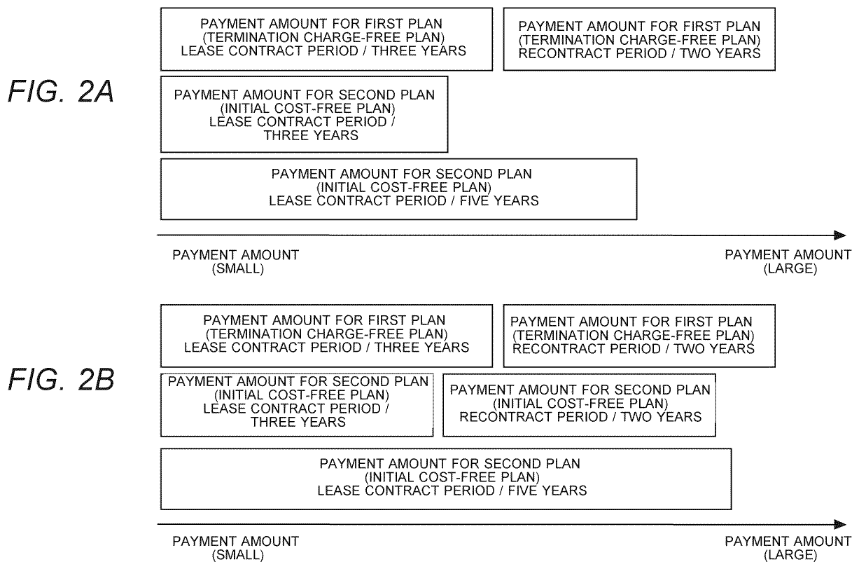

FIG. 2A is a chart illustrating a magnitude relationship among payment amounts for common contractual plans for a vehicle lease. Each rectangle in FIG. 2A represents the magnitude of a payment amount in one contract.

In the present embodiment, the first plan (termination charge-free plan) is a plan which offers only a three-year contract period as an option and can extend the contract period for additional two years for each re-signing operation. In contract, the second plan (initial cost-free plan) is a plan which allows selection of three years, five years, or seven years as a contract period and cannot extend the contract period by re-signing.

As illustrated in FIG. 2A, a contract for a lease contract period (three years) with the first plan is set larger in the total of a payment amount than a contract for the lease contract period (three years) with the second plan. However, a user can re-sign with the same plan (for two years, for example) with the same plan after expiration of the contract. In contract, although the second plan disallows re-signing after expiration of the lease contract period (three years), a monthly amount and the total of a payment amount are kept lower.

If periods up to delivery of new cars are lengthened due to, e.g., a supply chain disruption, a user after expiration of a contract with the second plan may get into a situation where the user cannot switch to a new vehicle and cannot re-sign the contract.

To help a user in such a case, the idea of allowing re-signing with the second plan after expiration of a lease contract period in the second plan is conceivable.

If the second plan is simply extended for two years by re-signing without changing a conventional payment amount setting, a magnitude relationship among payment amounts is as in FIG. 2B.

In this case, signing of a two-year recontract with the second plan after the end of a lease contract period (three years) with the second plan is smaller in the total of a payment amount than signing of a two-year recontract with the first plan after the end of a lease contract period (three years) with the first plan.

A user who selects the first plan is assumed to have decided to select, at the beginning of a lease contract, the first plan involving a payment amount set larger than the second plan that disallows re-signing in view of the advantage that the lease contract can be re-signed.

If re-signing with the second plan is possible, a contract can be continued with a low fee for a period equivalent to that in the case of re-signing with the first plan. That is, a difference in the burden of a payment amount is generated between a user which selects the second plan at the beginning of a contract and then re-signs with the second plan and a user which selects the first plan and then re-signs with the first plan. To reduce the difference, it is preferable to set the total of a payment amount for the first plan in the case of re-signing smaller than the total of a payment amount for the second plan in the case of re-signing.

This allows enhancement of satisfaction of a user which has been under contract with first plan from the beginning.

The server apparatus 100 receives, from the user terminal 200, a request giving an instruction to output information on a payment amount for a contractual plan (the first plan or the second plan) which a user is to re-sign up for after expiration of a lease contract period. The server apparatus 100 transmits the information on the payment amount for the contractual plan (the first plan or the second plan) set above to the user terminal 200 in response to the request.

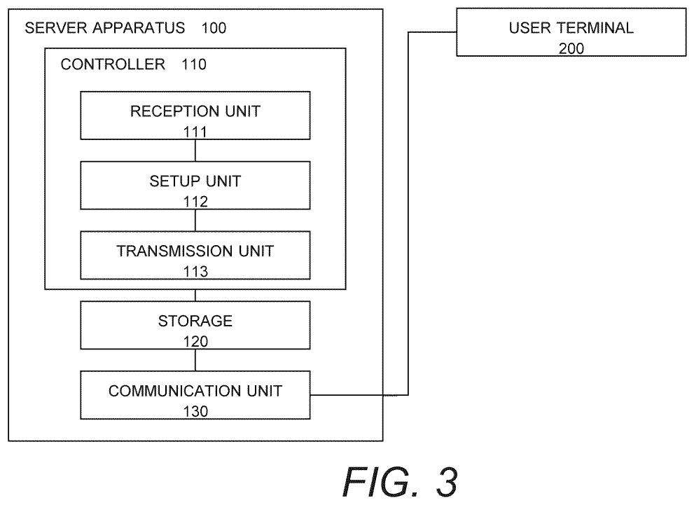

Elements which make up a system including the server apparatus 100 will be described in detail. FIG. 3 is a diagram for explaining constituent elements which the system including the server apparatus 100 according to the embodiment has.

The server apparatus 100 according to the present embodiment includes a controller 110, a storage 120, and a communication unit 130. The server apparatus 100 communicates with the user terminal 200 via the communication unit 130.

The controller 110 is implemented by a processor, such as a CPU (Central Processing Unit) or a GPU (Graphics Processing Unit), and a memory. The controller 110 includes, as functional modules, a reception unit 111, a setup unit 112, and a transmission unit 113. These functional modules may be implemented through execution of a program by the controller 110.

The reception unit 111 receives first information that is a request giving an instruction to output information on a payment amount for a contractual plan (the first plan or the second plan) to be re-signed up for to the user terminal 200. The reception unit 111 also receives second information that is a request giving an instruction to output information on a monthly amount of the payment amount for the contractual plan (the first plan or the second plan) to be re-signed up for to the user terminal 200. The reception unit 111 receives the first information or the second information transmitted from the user terminal 200 via the communication unit 130.

The setup unit 112 sets a payment amount during a recontract period in the case of re-signing up for a contractual plan after expiration of a lease contract period for the contractual plan. Specifically, the setup unit 112 sets the payment amount (a total payment amount and a monthly payment amount) for the contractual plan such that the total of a payment amount for the second plan during the recontract period is larger than the total of a payment amount for the first plan during the recontract period.

Note that, although a case where the setup unit 112 sets the payment amount during the recontract period for the first plan such that the total of the payment amount for the second plan during the recontract period is larger than the total of the payment amount for the first plan during the recontract period has been illustrated here, a method for setting a payment amount is not limited to this. Another example of a method for setting a payment amount by the setup unit 112 will be described later.

The transmission unit 113 transmits information on a payment amount for a contractual plan during a recontract period to the user terminal 200 on the basis of a payment amount for the contractual plan set by the setup unit 112, in response to first information. The transmission unit 113 transmits the information on the payment amount for the contractual plan to the user terminal 200, after the reception unit 111 receives the first information.

The transmission unit 113 also transmits information on a monthly amount of the payment amount for the contractual plan during the recontract period to the user terminal 200 on the basis of a monthly amount of the payment amount for the contractual plan set by the setup unit 112, in response to second information. The transmission unit 113 transmits the information on the monthly amount of the payment amount for the contractual plan to the user terminal 200, after the reception unit 111 receives the second information.

The storage 120 is a main memory, such as a RAM or a ROM, and an auxiliary memory, such as an EPROM, a hard disk drive, or a removable medium. An operating system (OS), various types of programs, various types of tables, and the like are stored in the auxiliary memory, and functions tailored to a predetermined purpose of the components of the controller 110 can be implemented through execution of a program stored therein. Note that some or all of the functions may be implemented by a hardware circuit, such as an ASIC or an FPGA.

The storage 120 stores data and the like used or generated by a process performed by the controller 110. The storage 120 may store information on respective payment amounts during a lease contract period corresponding to the first plan and the second plan. Note that the storage 120 may store data and the like on criteria for calculating a payment amount for the first plan, the second plan, or the like.

The communication unit 130 is composed of a communication circuit which performs wireless communication. The communication unit 130 may be, for example, a communication circuit which performs wireless communication using 4G (4th Generation) or a communication circuit which performs wireless communication using 5G (5th Generation). The communication unit 130 may be a communication circuit which performs wireless communication using LTE (Long Term Evolution) or a communication circuit which performs communication based on LPWA (Low Power Wide Area). The communication unit 130 may be a communication circuit which performs wireless communication using Wi-Fi®.

An apparatus other than the server apparatus 100 will be described.

The user terminal 200 is a terminal which accesses a lease site (a website for signing a vehicle lease contract) through the web browser. For example, the user terminal 200 may be a smartphone, a tablet terminal, a personal computer, or the like. The user terminal 200 communicates with the server apparatus 100 and transmits first information or second information. The user terminal 200 receives, from the server apparatus 100, information on a payment amount for a contractual plan or information on a monthly amount of the payment amount for the contractual plan. The user terminal 200 may output the information on the payment amount for the contractual plan or the information on the monthly amount of the payment amount for the contractual plan that is received on a display unit or the like of the user terminal 200.

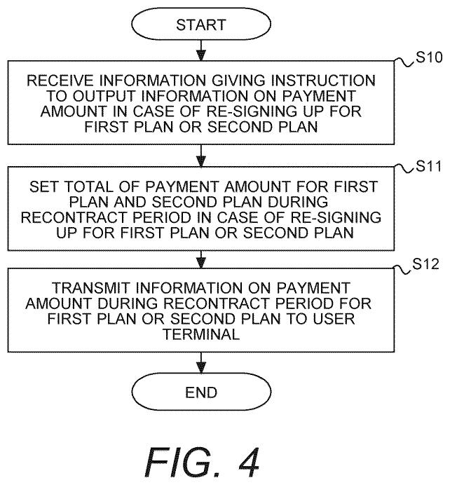

Specific details of a process to be performed by the server apparatus 100 of the embodiment will be described. FIG. 4 is a flowchart of a process to be executed by the controller 110 of the server apparatus 100 according to the embodiment.

The process illustrated in FIG. 4 is started at a time when the user accesses the server apparatus 100 via the user terminal 200 in order to re-sign a vehicle lease contract.

First, in step S10, the reception unit 111 receives first information that is information giving an instruction to output information on a payment amount in the case of re-signing up for the first plan or the second plan. The reception unit 111 receives the first information from the user terminal 200. The reception unit 111 may receive second information that is information giving an instruction to output information on a monthly amount of the payment amount in the case of re-signing up for the first plan or the second plan from the user terminal 200.

Next, in step S11, if the reception unit 111 has received the first information, the setup unit 112 sets the totals of payment amounts for the first plan and the second plan during a recontract period in a case where the user re-signs up for the first plan or the second plan.

Note that, if the reception unit 111 has received the second information, the setup unit 112 may set monthly amounts of the payment amounts for the first plan and the second plan during the recontract period in the case where the user re-signs up for the first plan or the second plan.

Next, in step S12, if the reception unit 111 has received the first information, the transmission unit 113 transmits information on the payment amount during the recontract period for the first plan or the second plan to the user terminal 200. The transmission unit 113 transmits the information to the user terminal 200 in response to the first information received by the reception unit 111.

In step S12, if the reception unit 111 has received the second information, the transmission unit 113 transmits information on the monthly amount of the payment amount during the recontract period for the first plan or the second plan to the user terminal 200. The transmission unit 113 transmits the information to the user terminal 200 in response to the second information received by the reception unit 111.

Note that, in step S11 described earlier, the setup unit 112 may set the totals of the payment amounts for the first plan and the second plan during the recontract period in the following manner.

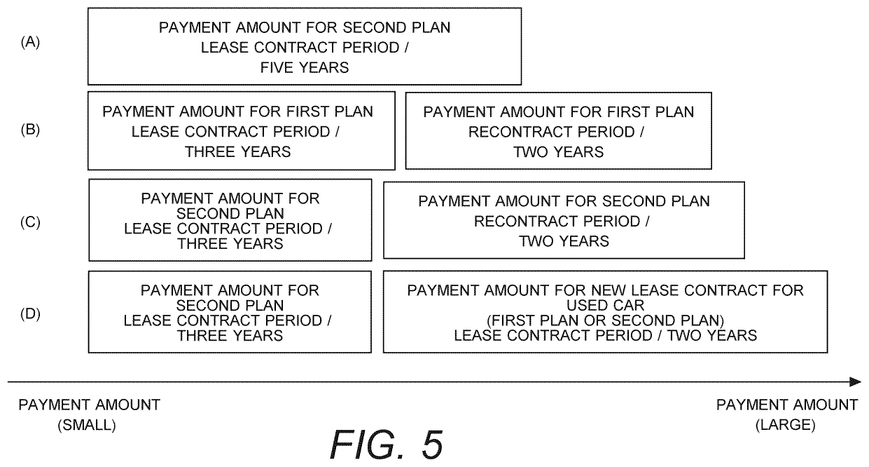

FIG. 5 is a chart illustrating a magnitude relationship among payment amounts for contractual plans to be set by the server apparatus 100 according to the embodiment. The setup unit 112 can set a payment amount for each contractual plan by one of the methods to be described below.

As described earlier, the setup unit 112 can set the totals of payment amounts during a recontract period such that the total of a payment amount for a recontract period in a case ((C) in FIG. 5) where a user re-signs up for the second plan is larger than the total of a payment amount for the recontract period in a case ((B) in FIG. 5) where the user re-signs up for the first plan. This can be implemented by, for example, making a discount of a payment amount (reference numeral 501) during the recontract period (two years) for the first plan off an original amount.

Note that the setup unit 112 may set only the total of a payment amount or may set a monthly amount of the payment amount during the recontract period.

With the above-described payment amount setting, for example, the total of a payment amount during a combined period of a lease contract period (three years) and a recontract period (two years) for the second plan is larger than the total of a payment amount during a combined period of a lease contract period (three years) and a recontract period (two years) for the first plan. Note that the total of a payment amount for a lease contract period (five years) for the second plan may be smaller than the total of the payment amount during the combined period of the lease contract period (three years) and the recontract period (two years) for the first plan.

Note that, in the above-described method, a payment amount (reference numeral 502) during a recontract period for the second plan is set larger than a payment amount (reference numeral 501) during the recontract period for the first plan. If a lease contract for a different used car is newly signed after expiration of a lease contract, the total of an amount in the case where the lease contract for the different used car is newly signed may be smaller than an amount paid for (B) in FIG. 5.

For this reason, the setup unit 112 may set the total of a payment amount in the case of signing a lease contract for a different used car for a first period larger than the total of a payment amount during a recontract period after expiration of a lease contract period with the second plan. The first period here refers to a period identical to the recontract period. The new lease contract for the used car is signed with the first plan or the second plan.

With the above-described payment amount setting, for example, the total of a payment amount during a combined period ((D) in FIG. 5) of a lease contract period (three years) and a new lease contract period (two years) for a used car for the second plan is larger than the total of a payment amount during a combined period ((C) in FIG. 5) of a lease contract period (three years) and a recontract period (two years) for the second plan.

Note that, in the above-described method, a payment amount (reference numeral 501) during a recontract period for the first plan is set smaller than a payment amount (reference numeral 502) during the recontract period for the second plan. If a total payment amount in the case ((B) in FIG. 5) of re-signing with the first plan is smaller than a total payment amount in the case ((A) in FIG. 5) of signing a five-year contract with the second plan at the beginning, an imbalance in financial burden with a user which signs a five-year contract with the second plan at the beginning may be created.

For this reason, the setup unit 112 may set a total payment amount for a recontract period for the first plan such that the total of a payment amount during a combined period for the first plan in the case of signing a contract for a lease contract period at the time of first signing and signing the contract for the recontract period after expiration is larger than the total of a payment amount for the second plan in the case of signing a contract for a combined period (five years) at the time of first signing. The combined period here refers to a period (five years) which is a first lease contract period (three years) and a recontract period (two years) combined. Note that the total of the payment amount for the second plan in the case of signing the contract for the combined period at the time of first signing refers to the total of a payment amount for the second plan during a period (five years) identical to the combined period in the case of signing a lease contract for the period at the time of first signing.

Note that the setup unit 112 may set, to identical amounts, a monthly amount of a payment amount for the second plan in the case of signing a lease contract for a combined period (five years) at the time of first signing and a monthly amount of a payment amount for the second plan in the case of signing a lease contract for a lease contract period (three years) at the time of first signing and signing the lease contract for a recontract period (two years) after expiration. The monthly amounts of the payment amounts here are both monthly amounts of payment amounts during the recontract period. Note that a monthly amount of a payment amount refers to an amount obtained by dividing a total payment amount during a contract period, such as a lease contract period, a recontract period, or a combined period, for each contractual plan by the number of months in the contract period. Note that a monthly amount of a payment amount may be adjusted so as to be larger in a particular month, such as a bonus month.

With the above-described payment amount setting, the total of a payment amount for the second plan in the case of signing a contract for a combined period at the beginning is smaller than the total of a payment amount for the first plan during the combined period in the case of signing a contract for a lease contract period at the beginning and further signing the contract for a recontract period after expiration.

As described earlier, the server apparatus 100 sets a payment amount during a recontract period such that the total of a payment amount during the recontract period is smaller in a case where a contractual plan is the first plan than in a case where the contractual plan is the second plan.

A user who selects the first plan is a user who selects a more expensive plan in view of the possibility of extension of a contract period. The server apparatus 100 according to the present embodiment can set a payment amount which does not give a sense of unfairness to such a user.

The server apparatus 100 makes settings such that the total of a payment amount during a recontract period is larger in the case of signing a new lease contract for a used car than in the case of re-signing a contract for a new car with the first plan or the second plan. This allows the server apparatus 100 to avoid a situation where the total of a payment amount is smaller in the case of returning a leased vehicle and newly signing a lease contract for a different used car than in the case of re-signing with an identical contractual plan after expiration of a lease contract period.

The server apparatus 100 sets a payment amount such that the total of a payment amount during a combined period is larger in the case of signing a lease contract for a period identical to a recontract period after expiration of a lease contract period than in the case of signing a lease contract during a period which is an original lease contract period and the recontract period combined at one time at the time of first signing. This allows the server apparatus 100 of the present disclosure to avoid an unreasonable payment amount setting in which the total of a payment amount is smaller in the case of re-signing after expiration of a lease contract period than in the case of signing a lease contract for a long period which is the lease contract period and a recontract period combined. Thus, the server apparatus 100 of the present disclosure can enhance satisfaction of a user which signs a lease contract.

### (Modifications)

The above-described embodiment is just an example, and the present disclosure can be appropriately changed and implemented without departing from the spirit thereof.

For example, the processes and means described in the present disclosure can be freely combined and implemented unless a technical contradiction arises.

A process described as being performed by one apparatus may be shared and executed by a plurality of apparatuses. Alternatively, a process described as being performed by different apparatuses may be executed by one apparatus. In a computer system, by which type of hardware configuration (server configuration) functions are to be implemented is flexibly changeable.

Note that although an example where an object of a lease contract is a vehicle has been described in the present embodiment, anything may be selected as an object of a lease contract. For example, an object of a lease contract may be a machine, furniture, fixtures, or the like.

The present disclosure can also be realized by supplying a computer program implementing the functions described in the above embodiment to a computer, and one or more processors included in the computer read out and execute the program. Such computer programs may be provided to a computer by a non-transitory computer-readable storage medium connectable to a system bus of the computer, or may be provided to the computer over a network. A non-transitory computer-readable storage medium includes, for example, any type of disk, such as a magnetic disk (floppy disk, hard disk drive (HDD), etc.), an optical disk (CD-ROM, DVD disk, Blu-ray disk, etc.), read-only memory (ROM), random access memory (RAM), EPROM, EEPROM, magnetic card, flash memory, optical card, any type of medium suitable for storing electronic instructions.

What is claimed is:

1. An information processing apparatus comprising a controller comprising at least one processor configured to perform:
receiving, from a user terminal, first information giving an instruction to output information on a payment amount in a case of re-signing up for at least one of contractual plans for a lease contract for an object, which are a first plan involving an initial cost at the time of signing of the lease contract and not involving an early termination charge during a lease contract period and a second plan not involving the initial cost at the time of signing of the lease contract and involving the early termination charge during the lease contract period, after expiration of the lease contract period;
setting the payment amount for each of the contractual plans during a recontract period such that a total of the payment amount during the recontract period is larger in a case where the contractual plan is the second plan than in a case where the contractual plan is the first plan; and
transmitting information on the payment amount during the recontract period to the user terminal in response to the first information.

2. The information processing apparatus according to claim 1, wherein
the object is an automobile, and
the at least one processor is further configured to execute
making a total of the payment amount during the recontract period in a case of signing the lease contract for a new car with the second plan and re-signing up for the second plan after expiration of the lease contract period
larger than a total of the payment amount during the recontract period in a case of signing the lease contract for the new car with the first plan and re-signing up for the first plan after expiration of the lease contract period and
smaller than a total of the payment amount during a first period which is a period identical to the recontract period in a case of signing a lease contract for a used car different from the new car for the first period with the first plan.

3. The information processing apparatus according to claim 1, wherein
the at least one processor is further configured to execute
setting the payment amount for each of the contractual plans such that
a total of the payment amount during a combined period of the lease contract period and the recontract period increases in the order of
(1) a total of the payment amount for the second plan during a period identical to the combined period in a case of signing the lease contract for the period identical to the combined period at the time of first signing,
(2) a total of the payment amount for the first plan during the combined period in a case of signing the lease contract for the lease contract period at the time of first signing and further signing the lease contract for a period identical to the recontract period after expiration of the lease contract period, and
(3) a total of the payment amount for the second plan during the combined period in a case of signing the lease contract for the lease contract period at the time of first signing and further signing the lease contract for a period identical to the recontract period after expiration of the lease contract period.

4. The information processing apparatus according to claim 1, wherein
the at least one processor is further configured to execute
setting, to identical amounts,
a monthly amount of the payment amount for the second plan during a period identical to the recontract period in a case of signing the lease contract for a period identical to a combined period of the lease contract period and the recontract period at the time of first signing and
the monthly amount of the payment amount for the second plan during the recontract period in a case of signing the lease contract for a period identical to the lease contract period at the time of first signing and further signing the lease contract for a period identical to the recontract period after expiration of the lease contract period.

5. The information processing apparatus according to claim 1, further comprising
a storage configured to store information on the payment amount during the lease contract period corresponding to each of the first plan and the second plan, wherein
the at least one processor is configured to execute
receiving, from the user terminal, second information giving an instruction to output information on a monthly amount of the payment amount during the recontract period for at least one of the first plan and the second plan as information on the payment amount in a case of re-signing up for the at least one of the first plan and the second plan,
calculating the monthly amount of the payment amount for the first plan and the second plan during the recontract period on the basis of the information stored in the storage such that a total of the payment amount during the recontract period is larger for the second plan than for the first plan, and
transmitting information on the monthly amount of the payment amount to the user terminal in response to the second information.
